(19) United States
(12) Patent Application Publication
(10) Pub. No.: US 2006/0144872 A1
(43) Pub. Date: Jul. 6, 2006

(54) Device for the portioned dispensing of contained product, and method of use thereof

(76) Inventors: Robert Keith Israel, Honolulu, HI (US); Shyrah Malia Israel Maurer, Honolulu, HI (US)

Correspondence Address: BAY AREA INTELLECTUAL PROPERTY GROUP, LLC, PO BOX 210459, SAN FRANCISCO, CA, 94121-0459, US

(21) Appl. No.: 11/029,057

(22) Filed: Jan. 3, 2005

(51) Int. Cl. G01F 11/26

(52) U.S. Cl. 222/454

(57) ABSTRACT

A consumer inserts a consumable product into a main storage area of the present device. A lid is secured to the top of the container. By tipping the container to the proper angle, product from main storage area is forced into holding barrier volume at the top of the container resulting in a specific amount of product to be held by the barrier. The container is then tipped upright and the measured product amount drops into the bottom of a measure compartment. The container is then inverted once more with the top of measure compartment now open, thereby allowing the measured product to be dispensed from the container, whereby the product from the main storage area is again forced into the holding barrier and process may be repeated.

### FIELD OF THE INVENTION

The present invention relates to dispensers. More particularly, the present invention relates to portioning dry granular dispenser.

### BACKGROUND OF THE INVENTION

Many portable devices have been proposed for the holding and dispensing various consumable products. Most known approaches require the consumer to use measuring devices such as spoons, scoops or cups to portion out product from container. Other known approaches are not convenient for single-handed operation. As a result, mobile or otherwise physically constrained consumers are often not able to conveniently dispense a certain amount of product contained within the portable dispenser. In some instances, this forces the consumer to inconveniently carry around the usually large container that the product was originally purchased in.

Currently, one identifiable dispenser products in the infant formula market is known to be intended for use while traveling. It is manufactured by a company named Munchkin Inc. located in North Hills, Calif. Their product is generally a pie-like shaped plastic container with three compartments into which the consumer puts in pre-measured servings of the product. The spout of the container is moved over the compartment that the consumer wants to dispense from. Unfortunately, the Munchkin dispenser suffers from the disadvantage of product undesirably shifting between the pre-measured compartments during travel, which is often a significant consumer complaint of such designs. Such approaches may be generalized as a “pre-dispensing” portioning of the consumable product. Their product is generally a multi cup container which has detachable compartments filled with pre-measured servings, which, again, is a “pre-dispensing” portioning approach. Such detachable compartments approaches, moreover, limit the consumer to only one serving without requiring the inconvenience of having the consumer measure and (re)load the dispensing device with a newly measured amount of the consumable product.

One of the challenges with dispensing granular product has been the need to measure portions prior to dispensing product into the end containers. However, the foregoing and similar devices are limited in their functionality, some by measuring without accurate control others by limiting the type of product dispensed and the need to attach to a primary container. Designs that require attachment to a primary container inherently suffer from the problem that the attaching portion of the device is confined to the geometry of the primary container.

Moreover, such designs have the further limitation of not providing the consumer with a one-handed operation and an accurately controlled measured dispensing device. Typically, if an inaccurate measurement is dispensed, the consumer must open the device, pour back the inaccurately measured amount, and repeat the dispensing steps. Known devices are also often configured to only hold a relatively limited amount of consumable product servings.

Known dispensing designs that include a measuring chamber and an internal holding area for the consumable product typically do not allow for easy dispensing of the consumable product into their holding area and often do not have a smooth internal wall surface from which the consumable product can move easily into the measuring chamber.

In view of the foregoing, what is needed is a portable, consumable-product dispensing container that is designed to automatically portion the consumable product before dispensing it for consumption. It would be desirable if the improved device is capable of convenient single handed operation. It would be further desirable if it were easy to travel with, easily cleaned, and relatively inexpensive to manufacture using common materials.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1a and b illustrate by way of example a top and side view, respectively, of a first embodiment of the present invention;

FIGS. 2a and b illustrate the measurement volume filling procedure for the embodiment of FIGS. 1a and b;

FIG. 3 illustrates the state of the present embodiment after the product dispenser 100 shown in FIG. 2b is turned upright;

FIG. 4 illustrates the state of the present embodiment after the product dispenser 100 shown in FIG. 3 is turned again upside down to outwardly discharge the measured product residing in measured volume 130;

FIGS. 5a and b illustrate by way of example a top and side view, respectively, of a second embodiment of the present invention;

FIGS. 6a and b illustrate the measurement volume filling procedure for the embodiment of FIGS. 5a and b;

FIG. 7 illustrates the state of the present embodiment after the product dispenser 500 shown in FIG. 2b is turned upright; and

FIG. 8 illustrates the state of the present embodiment after the product dispenser 500 shown in FIG. 7 is turned again upside down to outwardly discharge the measured product residing in measured volume 530.

Unless otherwise indicated illustrations in the figures are not necessarily drawn to scale.

### SUMMARY OF THE INVENTION

To achieve the forgoing and other objects and in accordance with the purpose of the invention, a variety of techniques for the portioned dispensing of contained product are described.

A device and method of its use is provided to dispense a measured amount of a product contained therein. In an embodiment, to operate the device, the consumer first transfers bulk product from its original container into a main storage area removing a compression-sealed lid from a bottom container base. The consumer then fills main storage area up to the top of a measurement volume gate, and attaches a lid to the container base with a retractable lid cover mechanism in its closed position. The consumer then tilts the present dispensing device to a certain angle thereby allowing for product to slide from the main storage area down the sidewall of measurement volume gate and onto a barrier gate, thereby filling a barrier volume. The consumer then brings the present dispensing device to the upright position allowing measured product to fall from the barrier volume into the measurement volume while at the same time allowing residual product to fall back into the barrier volume, whereby the measurement volume is automatically refilled upon righting the present dispensing device to its vertical position to facilitate the rapid repeat of the foregoing dispensing process.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the present invention are discussed below with reference to the Figures. However, those skilled in the art will readily appreciate that the detailed description given herein with respect to these figures is for explanatory purposes as the invention extends beyond these limited embodiments.

The following embodiments shown and described present a device for the portioned dispensing of consumable product wherein the portions are automatically measured at the time of dispensing.

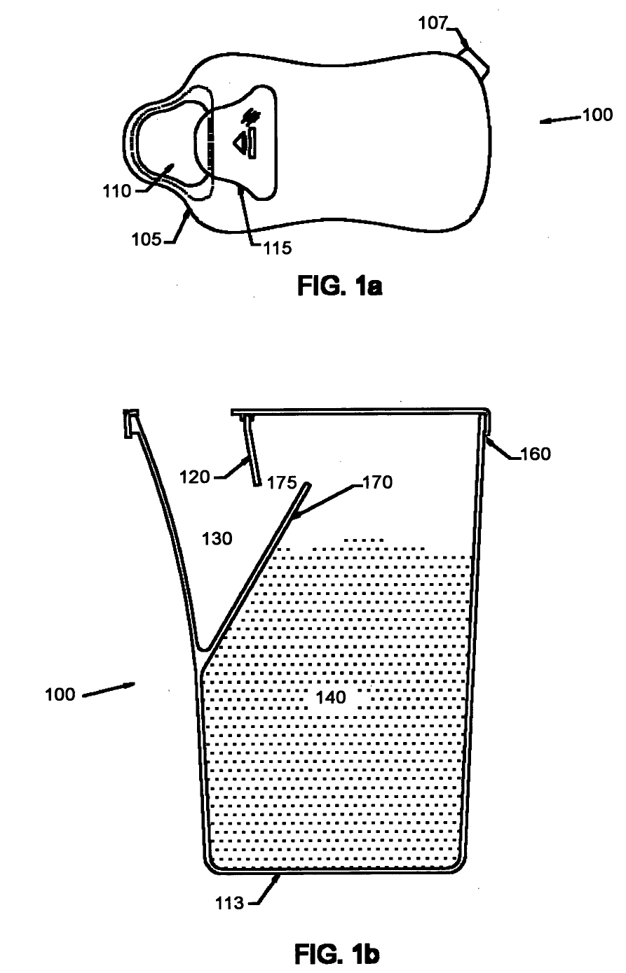

FIGS. 1a and b illustrate by way of example a top and transparent side view, respectively, of a first embodiment of the present invention. In the figures, a consumable product dispenser 100 is shown partially filled with an exemplary consumable product. FIG. 1a illustrates a lid 105 that is attached to the top of dispenser 100 and may be configured according to known techniques in the portable dispensing container arts. By way of example, and not limitation, a dispenser opening 110 is formed to provide an opening by which to exit the consumable product from dispenser 100. Dispenser opening 110 functionally cooperates with a Push/Pull retractable lid cover mechanism 115 to prevent leakage of the contained product. Retractable lid cover mechanism 115 may be controlled by the use of the consumer's finger (e.g., index finger) of the hand that is holding the dispenser. By way of further example, a pry tab 107 may be formed as a part of the lid 105 to enable easy removal from the container base 113. Lid 105 may be sealingly attached to container base 113 in any suitable manner in accordance with the teachings of the present invention. For example, a compression seal 160 as shown in the present example may be implemented using existing sealing technology, which allows a secure air-tight seal of lid 105 to the container base 113. The exemplary embodiment of lid 105 and retractable lid cover mechanism 115 is a typical implementation found in travel coffee mug applications; however, those skilled in the art will readily recognize alternative and suitable configurations of the dispenser top, sealing mechanism, and dispenser opening according to the needs of the particular application. Some embodiments of the present invention (not shown) may not include lid 105, or its equivalent, but otherwise function adequately for the intended purpose, with some possible performance degradation (e.g., some pre-mature leakage of product).

Referring now to FIG. 1b, dispenser 100 comprises a barrier gate 120, is sealingly attached (e.g. by a compression seal 160) at its top to lid 105 and sized to make a snug but removable fit against the inner walls of dispenser 100 such that a partial barrier is formed to create an upper partition between a measured volume 130 and a main storage volume 140. As will be explained in some detail below, measured volume 130 holds, for subsequent discharge out of dispenser opening 110, a measured amount of the product contained in a main storage volume 140, which contains transferred product from the product's original container. As will be apparent to those skilled in the art, the barrier gate may be implemented in a multiplicity of alternative and suitable ways in accordance with the teachings of the present invention. By way of example, and not limitation, alternative embodiments of the barrier gate may be sealingly attached at the sides to the inner walls of dispenser 100 instead of to the lid, and sized to make a snug but removable fit against the lid when the lid is in its closed position.

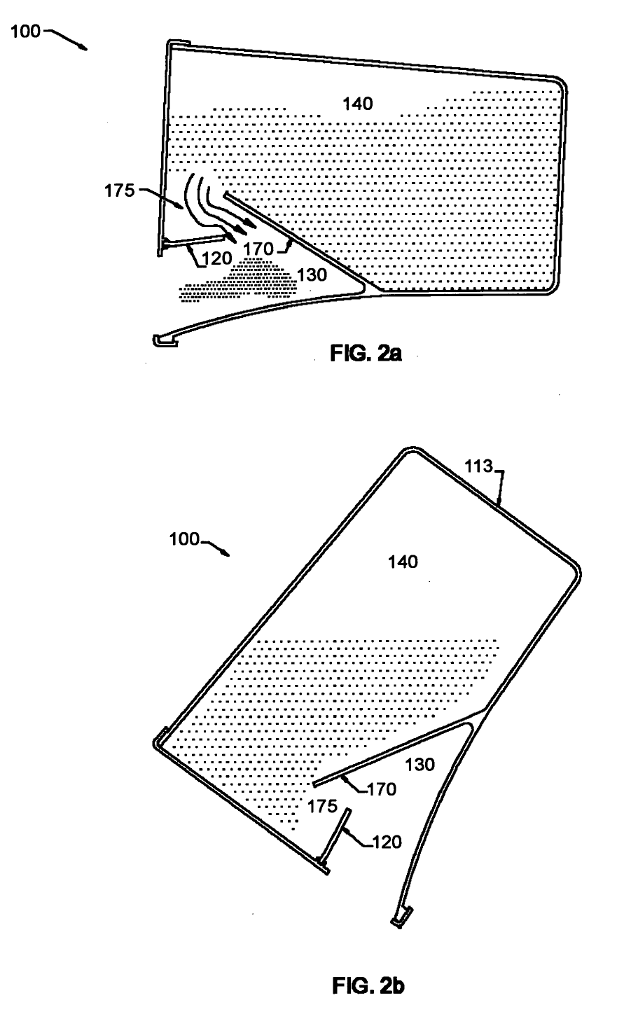

A measurement volume gate 170 is attached at an angle to the front wall of container base 113 such that it forms an upward opening V-shaped bottom partition between measured volume 130 and main storage volume 140 and there is a measurement volume filling inlet gap 175 between the bottom of barrier gate 120 and the top of measurement volume gate 170, thereby providing a conduit for the filling of measured volume 130 from main storage volume 140 (see FIGS. 2a and b). Hence, measurement volume gate 170 is angled from the inner front wall of container base 113 and acts as a front wall to the main storage volume 140.

To operate the present embodiment the consumer first transfers bulk product from its original container into the main storage volume 140 by removing the compression-sealed lid 105 from the bottom container base 113. The consumer can fill main storage volume 140 up to capacity (i.e., to the top of measurement volume gate 170), and reattaches lid 105 to container base 113 with the push/pull mechanism 115 preferably in its closed position.

FIGS. 2a and b illustrate the measurement volume filling procedure for the embodiment of FIGS. 1a and b. Preferably, making sure measured volume 130 is empty, the consumer then grips dispenser 100 such that retractable lid cover mechanism 115 rests at one side of the index finger and tilts apparatus to a sufficient angle allowing for product to slide down sidewall of measurement volume gate 170 onto barrier gate 120 from main storage volume 140. The determined degree of tilt may vary according to the amount of residual product in the main storage volume 140. That is, a first step towards filling measured volume 130 is shown in FIG. 2a, where product dispenser 100 is turned sufficiently upside down to fill the upper portion of product dispenser 100 herein referred to as a barrier volume with a desired volume of the product, wherein the barrier volume (not shown explicitly) is defined by lid 105 at the bottom, and is contained on four sides by measurement volume gate 170 in the front, and the back and side walls of container base 113.

A second step towards filling measured volume 130 is shown in FIG. 2b, where product dispenser 100 is turned sufficiently to its side from the upside down position to transfer a substantial portion of the desired volume described in FIG. 2a into measured volume 130 through measurement volume filling inlet 175. As shown in the Figure, an aspect of barrier gate 120 serves to restrict and measure the flow of product in main storage volume 140 when dispenser 100 is tipped towards its sideward position with dispenser opening 110 facing towards the ground.

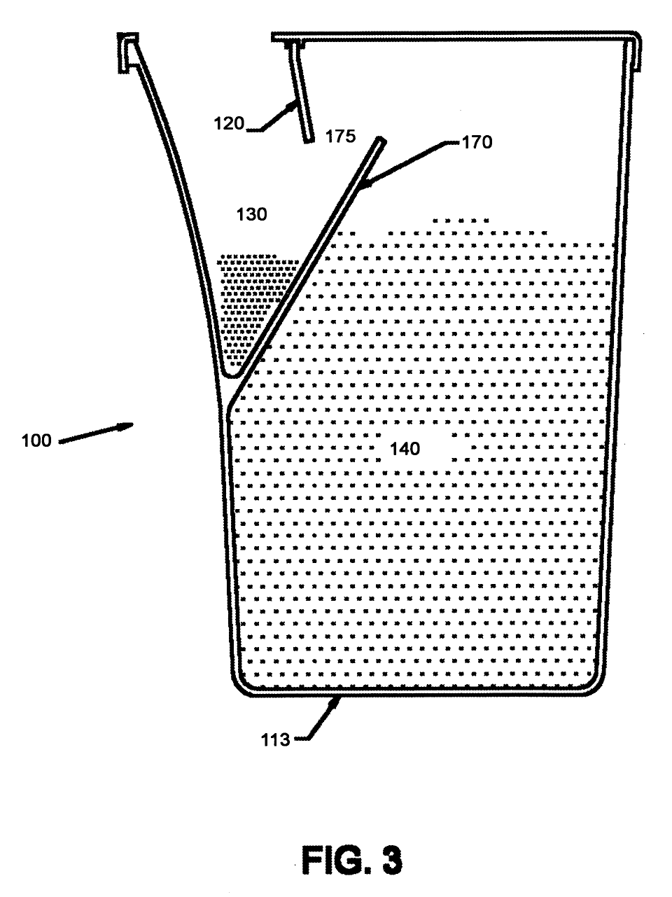

FIG. 3 illustrates the state of the present embodiment after the product dispenser 100 shown in FIG. 2b is turned upright. Typically, the consumer would bring product dispenser 100 to the upright position allowing measured product to fall from barrier gate 120 into measured volume 130 while at the same time allowing residual product to fall back into main storage volume 140. This procedure may be repeated to add additional product to measured volume 130 as needed before dispensing. In this way, there is a smooth filling of the product into the barrier volume when dispenser 100 is inverted and a further smooth filling of the product into measured volume 130 as dispenser 100 is righted into its upright position. As shown in the Figure, measurement volume gate 170 blocks flow of the product into measured volume 130 when dispenser 100 is re-inverted to its upright position. Retractable lid cover mechanism 115 is preferably closed (not shown) during this step to avoid premature spillage of the product being filled into measured volume 130.

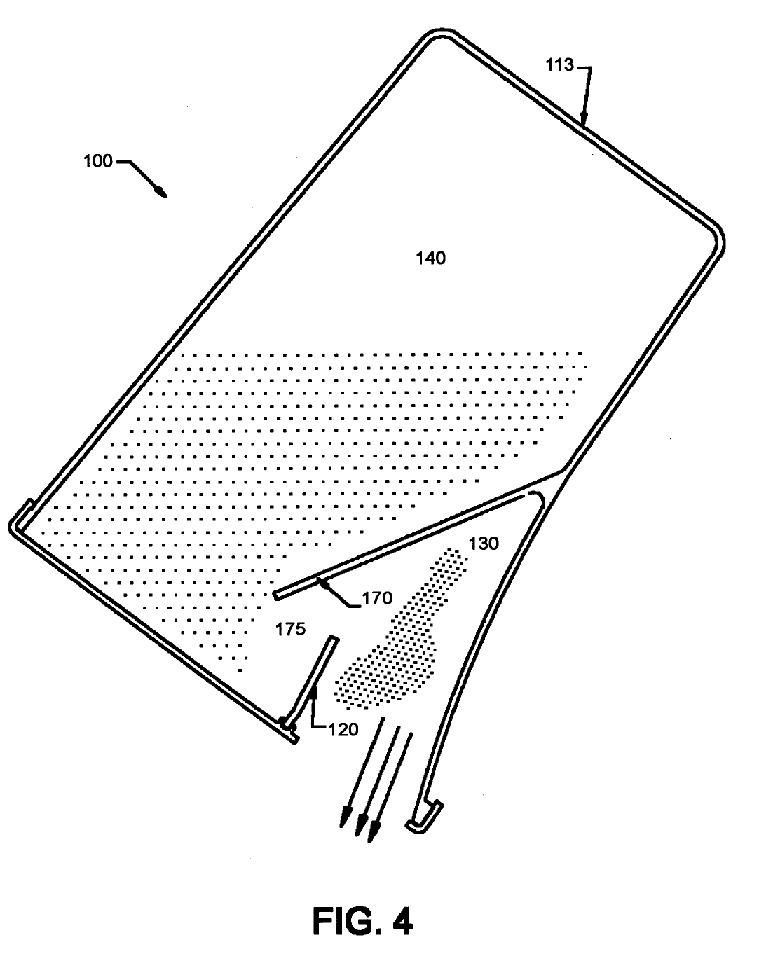

FIG. 4 illustrates the state of the present embodiment after the product dispenser 100 shown in FIG. 3 is turned again upside down to outwardly discharge the measured product residing in measured volume 130. Preferably, when the consumer is ready to dispense the measured product he or she then opens retractable lid cover mechanism 115 with his or her index finger while the container is in an upright position. The consumer then tips dispenser 100 allowing the product in the measured volume 130 to be dispensed into the desired receiving receptacle (e.g., a baby bottle, coffee filter, mug, glass, bowl, ones mouth, etc.) During this last motion, barrier gate 120 automatically reloads with product for the next usage cycle. That is, dispenser 100 is inverted once again with retractable lid cover mechanism 115 open, thereby allowing the measured product to be dispensed from dispenser 100, during which time the product from the main storage area is again forced into the barrier volume, whereby the process may be repeated again. When consumer is finished dispensing the desired portion retractable lid cover mechanism 115 is moved to its closed position. Anytime the consumer finds unwanted product in measured volume 130 (e.g., due to jostling of the dispenser during travel), he or she simply tips dispenser 100 backwards to empty any unwanted product back into main storage volume 140.

It should be appreciated that all of the foregoing steps towards measuring and discharging the product from product dispenser 100 may be achieved by way of a single-handed operation to invert and right dispenser 100. Thus, the consumer may measure and dispense contained product with the simple single-handed rotation of the present product dispenser and is, thereby, not required to actively pre-measure the amount of product to be dispensed; hence, there is no additional step of actively measuring the product and placing in the container as required by conventional approaches. Moreover, another aspect of dispenser 100 is that its active surfaces are readily accessible for cleaning or maintenance by the consumer.

The first embodiment is particularly suited for dispensing dry product, but may be suitably configured to handle liquid products as well. Those skilled in the art will readily recognize the proper configuration of measured volume 130, barrier gate 120, measurement volume gate 170, and measurement volume filling inlet 175 to provide suitably operable and convenient product dispensing depending on the particular product(s) and application(s) needs. By way of example, and not limitation, dispenser 100 may be configured to hold and measure a wide variety of materials such as powdered formula, coffee, tea, laxatives, powdered dietary supplements, cereals and standard food items such as sugar, flour, rice etc.

The components of dispenser 100 may be composed of any suitable material and formed by any suitable process known to those skilled in the art. By way of example, and not limitation, container base 113 may be manufactured from relatively inexpensive plastics or metals (e.g., stainless steel) using a relatively inexpensive molding process.

In addition to being designed for ease of use, the present embodiment is designed with smooth walls that allow for relatively unrestricted flow thereby tending to avoid product from being trapped.

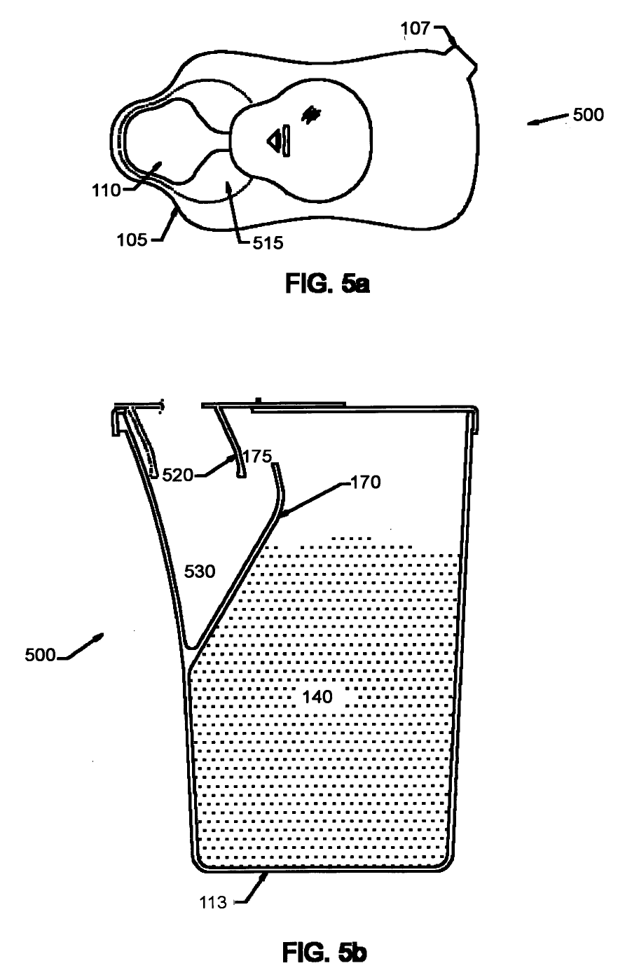

FIGS. 5a and b illustrate by way of example a top and transparent side view, respectively, of a second embodiment of the present invention. Shown in the Figure is an alternative to the fixed barrier gate measuring device of the first embodiment having instead a sliding barrier gate 520, which may be incorporated into a retractable lid cover mechanism 515 such that when in the closed position product is allowed to enter a measured volume 530 and when in the opened position blocks additional product from entering measured volume 530 while simultaneously opening measured volume 530 for discharge of product to the consumer's receptacle. The second embodiment is otherwise configured and operated similar to the first embodiment, as illustrated in the following figures.

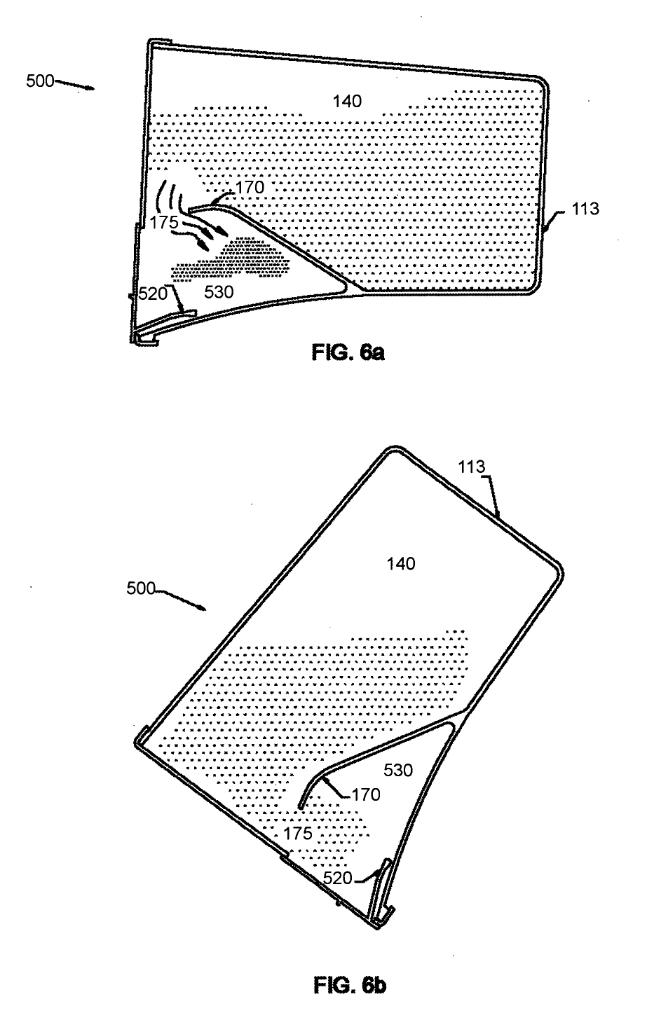

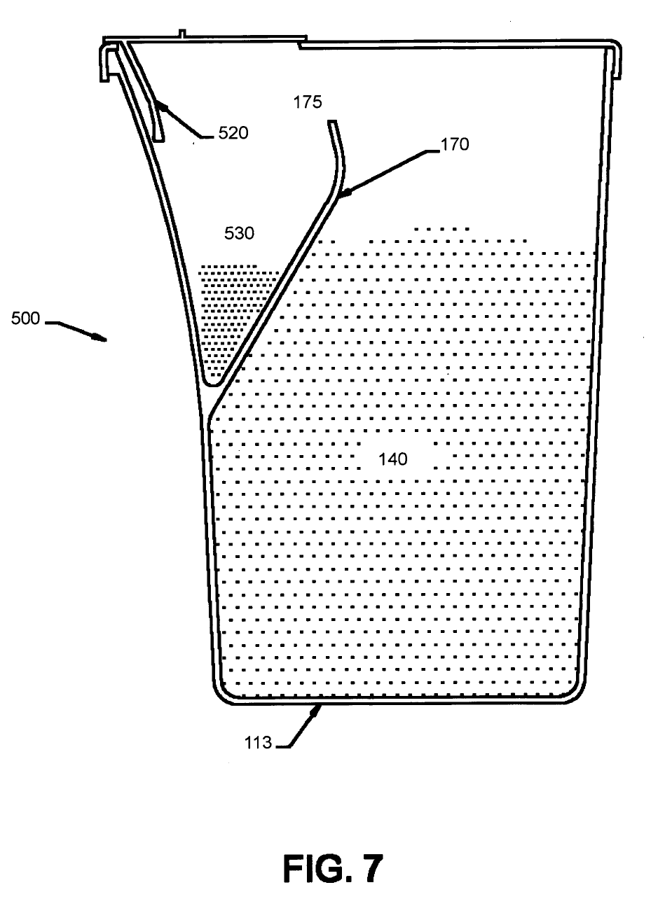

FIGS. 6a and b illustrate the measurement volume filling procedure for the embodiment of FIGS. 5a and b, wherein the consumer inverts the apparatus thereby allowing product to flow against sliding barrier gate 520 while in the closed position. FIG. 7 illustrates the state of the present embodiment after the product dispenser 500 shown in FIG. 2b is turned upright, wherein the consumer tilts the apparatus into the upright position, while in doing so allowing product to flow into measured volume 530.

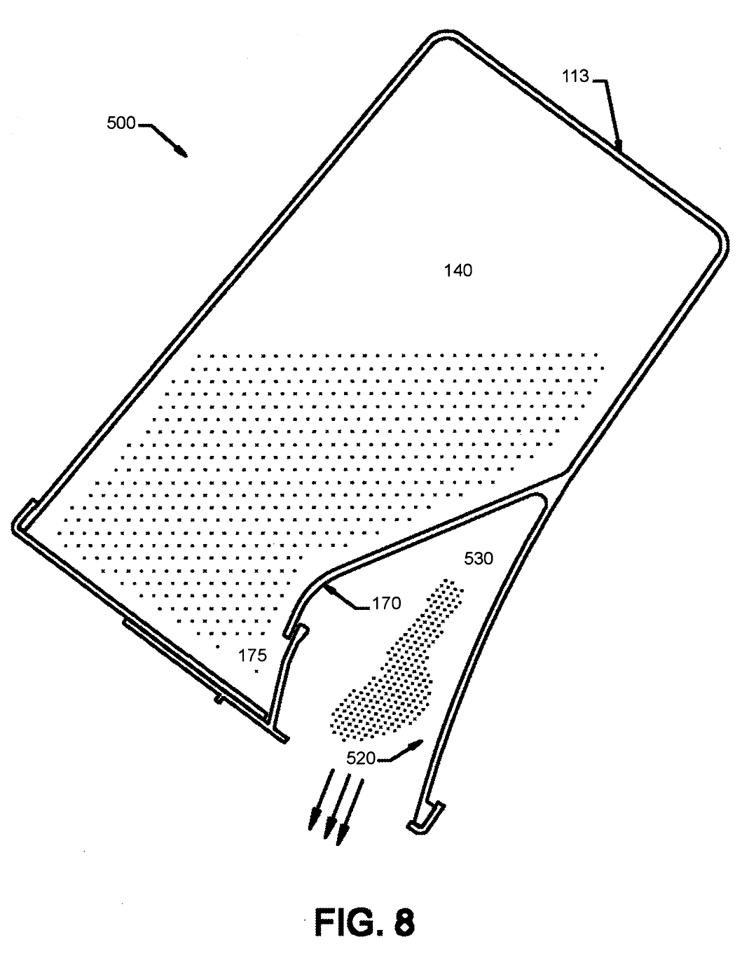

FIG. 8 illustrates the state of the present embodiment after the product dispenser 500 shown in FIG. 7 is turned again upside down to outwardly discharge the measured product residing in measured volume 530. That is, the consumer then retracts the sliding barrier gate 520 by way of retractable lid cover mechanism 515, thereby leveling the measured product while opening the pouring spout for dispensing. It should be appreciated that although the second embodiment differs somewhat in form from the first embodiment, the second embodiment possess substantially the same function attendant to the first embodiment. Those skilled in the art will readily recognize the optimal configuration of the sliding barrier gate and retractable lid cover mechanism for the particular application. By way of example, and not limitation, the retractable lid cover mechanism may be provided with a selectable locking mechanism that locks, at least to some degree, the retractable lid cover mechanism in place while in the closed position, to help avoid the retractable lid cover mechanism from sliding forward while discharging the measured product from the product dispenser. By way of further example, in applications for dispensing liquids, sliding barrier gate 520 might (possibly in addition to the foregoing locking mechanism) be provided with suitable sealing means to sufficiently seal the flow of product around sliding barrier gate 520 from the main storage volume into the measured volume while sliding barrier gate 520 is in the closed position.

One exemplary application of the present invention is described as follows: The consumer fills an embodiment of the present invention with an 8-12 oz bag of ground coffee, wherein the embodiment is manufactured such that the gate and inlet geometry are set to portion out, for example, one tablespoon of ground coffee product. Once the lid is placed on the device, the consumer with one hand simply tilts the apparatus to properly portion out enough ground coffee to make one cup of brewed coffee without the need to use an extraneous measuring device (e.g. measuring cups, spoons, etc). The consumer opens the retractable lid cover and pours the measured tablespoon of ground coffee into the coffee filter. Hence, the consumer no longer needs to regularly access the coffee bag each time he or she brews coffee.

Alternative embodiments of the barrier gate are contemplated (not shown) that instead of having the barrier gate fixed to the lid, retractable lid cover, or the sidewalls of the container base, an outwardly accessible lever is provided that directly closes or opens the barrier gate against the measurement volume gate, thereby enabling the consumer to open and shut off the measuring compartment. Such levered barrier embodiments of the present invention may have additional usefulness in applications for bulk dry product measurement of relatively large portions (e.g., cups).

Having fully described at least one embodiment of the present invention, other equivalent or alternative methods of dispensing automatically portioned products according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A device for the portioned dispensing of a contained product, the device comprising:
means for containing the product in a main storage volume;
means for measuring a portion of the product;
means for transferring the product to said portion measurement means from said main storage containing means;
means for containing at least some of the product transferred to said portion measurement means;
means for transferring at least some of the measured product in said portion measurement means to said measured portion containment means; and
means for dispensing at least some of the measured product in said measured portion containment means

2. The product portion dispensing device of claim 1, further comprising means for blocking the dispensement of at least some of the measured product from said measured portion containment means.

3. A method for the portioned dispensing of a contained product, the method comprising the steps of:
containing the product in a main storage compartment;
inverting said main storage compartment to transfer the product to a portion measurement end of said main storage compartment; and
righting said main storage compartment to automatically transfer at least some of the measured product from said portion measurement end to a measured portion dispensing compartment, said measured portion dispensing compartment being an adjacent compartment to said main storage compartment.

4. The portioned dispensing method of claim 2, further comprising the step of dispensing at least some of the measured product out of said measured portion dispensing compartment.

5. A device for the portioned dispensing of a contained product, the device comprising:
a main storage compartment for containing the product, the upper portion of said main storage compartment being configured with means for measuring a portion of the product such that the product may be transfer to said portion measurement means by inverting said main storage compartment;
a measured portion dispensing compartment, said measured portion dispensing compartment being an adjacent compartment to said main storage compartment;
means for transferring at least some of the measured product in said portion measurement means to said measured portion dispensing compartment, wherein the transfer to said measured portion dispensing compartment occurs upon righting said main storage compartment to transfer at least some of the measured product from said portion measurement means to said measured portion dispensing compartment.

6. The product portion dispensing device of claim 5, further comprising means for dispensing at least some of the measured product held in said measured portion containment means.

7. The product portion dispensing device of claim 6, further comprising means for blocking the dispensement of at least some of the measured product from said measured portion containment means.
